(19) United States
(12) Patent Application Publication
(10) Pub. No.: US 2024/0391213 A1
(43) Pub. Date: Nov. 28, 2024

(54) ALUMINUM FOIL LIDDING AND METHOD OF MAKING THE SAME

(71) Applicant: Chandrahas BABU KOTIAN, Nani Daman, UT of Daman and Diu (IN)

(72) Inventor: Chandrahas BABU KOTIAN, Nani Daman, UT of Daman and Diu (IN)

(21) Appl. No.: 18/693,916

(22) PCT Filed: Sep. 20, 2022
(86) PCT No.: PCT/IN2022/050838

§ 371 Date: Mar. 20, 2024

(30) Foreign Application Priority Data
Sep. 21, 2021 (IN) 202121042793

(51) Int. Cl. B32B 15/09; A61J 1/03; B32B 7/12; B32B 15/20; B32B 27/36; B65D 75/36

(52) U.S. Cl. CPC B32B 15/09; A61J 1/035; B32B 7/12; B32B 15/20; B32B 27/36; B65D 75/367; B32B 2255/06; B32B 2255/26; B32B 2307/31; B32B 2307/7376; B32B 2307/75; B32B 2439/40; B32B 2439/70; B32B 2439/80

(57) ABSTRACT

The present invention relates to an aluminium lidding foil for blister pack comprising a) a layer of aluminum foil, b) a layer of adhesive, c) and a layer of thin polymer film. The adhesive which is a solvent free adhesive is applied in between the aluminium foil layer and the thin polymer film layer. The outer surface of the aluminium foil is used for printing product details. The inner surface of the polymer film facing the aluminium foil can also be used for printing using any inks including anti-counterfeit ink. The polymer layer laminated to the inner surface of the aluminium foil acts as a barrier and prevents direct contact of printing ink with medicines/confectionery products packed in the blister pack. The thin polymer film eliminates possibility of chemical contamination into the product and the problem of residual solvents in present heat seal lacquer coated blister lidding foil.

### FIELD OF INVENTION

The present disclosure relates to the field of packaging materials. More particularly the present disclosure relates to aluminium lid foil used in blister packaging, wherein polymer film is used in place of chemical coating. This invention finds application in confectionery and pharmaceutical industries as packaging material.

### BACKGROUND OF INVENTION

Blister packs are mainly used in packaging of pharmaceutical products and for confectionery products. The blister packs comprise of a cavity or pocket made from a formable film, for example, plastics such as PVC, polyamides, polyolefins, polyesters, BOPA (Biaxially Oriented PolyAmide)/nylon film and laminates or multi-layered materials containing at least one of these materials and, if desired, may also contain an aluminium foil as one of the layers. The second part of the blister pack is backing of a heat sealable lidding aluminum foil which comprise a hard or soft aluminium foil which is a material of choice for the lids on blister packs, as the thickness of the aluminium foil material used requires relatively little force for it to break. This aluminium foil is coated with heat seal lacquer (HSL) on one side to seal with the blister pack and the other side of the foil is washed with foil wash solution such as shellac wash, or coated with primer to make the surface suitable for printing.

U.S. application No. 20050061705 relates to a pharmaceutical blister with reduced permeability to water vapour and gas. It is proposed according to the invention to coat conventional blisters with a silicon oxide-containing functional layer to protect against gases, water vapour and organic molecules. However, this process is expensive and time consuming.

WO2007072494A1 discloses a multi-layer thermoformed container having a lid and a base, the base comprising pharmaceutical and food packaging film substrate of thickness 100 to 1000 microns of food grade polyvinyl chloride. The multi-layer thermoformed container comprises a metallized layer of a thickness of 0.02 to 0.2 microns provided on one side of the said substrate and the food packaging film has an opacity of 95% to 100% in its flat underformed configuration and an opacity of 35% to 45% in its deformed configuration in which at least one blister is thermoformed therein.

US20160001952A discloses a multilayer cold-formable film carrying an image and having a thickness in the range of 100 to 300 micron. The said film comprises a first layer comprising: a peelable carrier having a thickness ranging from 10 to 20 micron; a coat of an ester acrylic based primer having a thickness ranging from 0.1 to 10 micron on said carrier; a metallized layer having a thickness ranging from 0.001 to 0.3 micron deposited on said coat; an adhesive coat provided on said metalized layer; and an image of a pre-determined pattern embossed on said coat forming an embossed surface. The film further comprises a base layer having a thickness ranging from 100 to 250 micron laminated to said embossed surface of the first layer.

US20180110679A1 discloses a pharmaceutical pack and the method for making the same. The pharmaceutical pack includes a blister layer and a lidding sheet disposed over the blister layer. The blister layer defines at least one opening. The lidding sheet includes a first layer and optionally a second layer. The first layer includes at least one hologram, and is disposed on the second layer, which is a plastic film. The blister layer and the lidding sheet define at least one cavity so as to hold at least one pharmaceutical dosage form therein.

CN2603026Y discloses cold stamping type plastics-aluminium combined diaphragm for high seal package. CN101318395B relates to a preparation method for a medical cold-forming compound aluminium foil. WO2007072505 relates to a metallized packaging blister container.

There are several disadvantages in the materials and the method which is currently being used. Currently, aluminium foil is heat sealed on to the base plastic material while packaging blister packs. The heat sealing is achieved by coating a solvent based vinyl/acrylic resin which are dissolved in suitable solvents like ethyl acetate, acetone, methyl ethyl ketone (MEK) etc called heat seal lacquer, on aluminum foil and pressing the foil on to the base plastic; usually a blister pack. After coating the heat seal lacquer, it is dried using hot air dryers. The use of hot air dryers does not achieve 100% solvent evaporation due to technical limitations. Printing is also done sometimes on surface of the aluminium foil where the heat seal lacquer is applied. The residual solvents, pigments, dyes and other chemicals, which are used in heat seal lacquer and printing ink of printed matter on foil used in blister pack as lidding foil, may affect or devalue the medicine or other edible content packed in it. The residual solvents of heat seal lacquer and other chemicals used in printing inks are unsafe or hazardous in nature. Therefore, there is a need for a safe blister pack, which eliminates all the drawbacks associated with the presently available aluminum lidding foil. So, to avoid and eliminate these problems, inventors of this invention have developed an aluminium lidding foil as disclosed in the present application. The present invention eliminates those chemical contamination in medicines and confectionery products packaging.

### SUMMARY OF INVENTION

An object of the invention is to provide an aluminium lidding foil for blister packs, for providing a contamination fee packaging of goods, wherein the vapor from heat seal lacquer does not react with the medicine or the edible content in the packet.

It is another object of the invention to provide an alternative for the heat seal lacquer by way of a thin polymer film as one of the sealing layers in a blister pack. A laminated polymer/PCV film will replace solvent based heat seal lacquer (HSL) coating which is used in current practice, thereby preventing direct contact of any chemicals, solvents, inks, pigments and dyes to the pharmaceutical and confectionery products packed in the blister pack.

The aluminum lidding foils as per the present invention will have a layer of thin plastic polymer film on the side which seals the blister pack. The thin polymer film having a thickness of 3 to 13 microns is provided to fulfil the necessity of heat sealing with PVC layer of the blister pack. The thin polymer film is selected from any plastic polymer, most preferably the same polymer as the blister pack on which it has to be heat sealed.

In an embodiment the thin polymer film is a PVC film. The thin PVC film has easy breaking properties in order to achieve the push-through open requirements in blister packing for solid dose medicines and confectionery products.

In a process of lidding the blister pack with the disclosed aluminium foil, wherein the aluminium foil is laminated with the thin plastic polymer towards the side which attaches to the blister pack, heat and pressure is applied to seal the blister pack. The heat will liquefy the thin plastic polymer and the pressure applied will cause the liquified plastic polymer to seal the blister pack. Advantageously, using the thin plastic polymer layer instead of a heat seal lacquer eliminates the volatile hazardous gases which will otherwise get entrapped in the blister pack due to the heat sealing of the heat seal lacquer. Therefore, the present invention which discloses an aluminum lidding foil comprising a laminated thin polymer film as one of the layers, wherein including this layer enables chemical contaminant free laminate/packaging of the blister pack as it does not involve solvents. As volatile chemicals or solvents are not formed during heat sealing, there is no problem of migration of the volatile solvents as in the case of coating with heat seal lacquer in the prior art.

Another advantage of the invention is; in an aluminium foil where the printing is carrier out on the reverse side of the film as well, where the print side doesn't face the pharmaceutical or confectionery product packed in the blister pack; there is no chance of migration of the printing inks, pigments and dyes into medicines and through the medicines into the human body, when a thin polymer film laminate is present between print surface and products content as in the present invention. The thin polymer film block any inks and other leakage of chemical from reaching the content of the blister pack.

The various embodiments of the aluminium lidding foil for blister pack are as given below.

Embodiment A relates to a laminated lidding foil (100) for blister container comprising
a layer of aluminum foil (110),
a layer of adhesive (120),
a layer of polymer film (130),
optionally, a primer coating is applied on one (105) or both sides (105, 125) of the aluminum foil, and
wherein the primer coated layers provides printing surface.

Embodiment B relates to the laminated lidding foil (100) as recited hereinabove wherein the polymer film which is the layer (130) is selected from poly vinyl chloride (PVC), polyamides, polyolefins, polyesters and laminates or materials containing at least one of these.

Embodiment C relates to the laminated lidding foil (100) as recited hereinabove wherein the layer (130) which is the polymer film has a thickness of 3 to 13 microns, most preferably a thickness of 5 to 10 microns.

Embodiment D relates to the laminated lidding foil (100) as recited hereinabove wherein the polymer film which is the layer (130) is heat sealed on to a polymer base (150).

Embodiment E relates to the laminated lidding foil (100) as recited hereinabove wherein the polymer film layer (130) and the polymer base (150) is made of same class of polymer.

Embodiment F relates to the laminated lidding foil (100) as recited hereinabove wherein the adhesive (120) is a solvent free adhesive.

Embodiment G relates to the laminated lidding foil (100) as recited hereinabove wherein the adhesive (120) is selected from vinyl and/acrylic/polyurethane/polyol/epoxy.

Embodiment H relates to the laminated lidding foil (100) as recited hereinabove wherein the adhesive (120) is applied between the aluminum foil and the polymer film for lamination.

Embodiment I relate to the laminated lidding foil (100) as recited hereinabove wherein printing is done on aluminum foil (105) and/or interior side of the aluminum foil (125) with printing ink or anti-counterfeit security inks.

Embodiment J relates to the laminated lidding foil (100) as recited hereinabove comprising an additional layer of PET/plastic film of 10 to 25 micron above the aluminum foil (110) layer.

Embodiment B relates to the laminated lidding foil (100) as recited hereinabove wherein the aluminum foil (110) is soft aluminium foil with a thickness of 7 to 15 micron.

Embodiment B relates to a blister package for food or pharmaceutical packaging comprising the laminated lidding foil as recited hereinabove.

The above embodiments A to J are described in detail below.

### BRIEF DESCRIPTION OF DRAWINGS

FIG. 1 illustrates a scheme wherein the lidding material (1) and thermoformed blister is used in an industrial process to package edible components.

FIG. 2 illustrates images of A) Thermoformed blister and B) lidding material.

FIG. 3 illustrates an embodiment of the multiple layers of the multilayer package as per the present invention comprising a layer of aluminum foil, an adhesive layer, a first polymeric film layer and a second polymeric film layer which forms a blister.

FIG. 4 illustrates another embodiment of the multiple layers of the multilayer package as per the present invention comprising a layer of aluminum foil, an adhesive layer, a first polymeric film layer and a second polymeric film layer which forms a blister; wherein the exterior side of the aluminum foil layer is printed using primer or ink.

FIG. 5 illustrates yet another embodiment of the multiple layers of the multilayer package as per the present invention comprising a layer of aluminum foil, an adhesive layer, a first polymeric film layer and a second polymeric film layer which forms a blister; wherein the exterior side of the aluminum foil layer and the laminating side of the polymer film is printed using printing inks or anti-counterfeit security inks.

### DETAILED DESCRIPTION OF THE INVENTION

The present invention will now be described more fully herein after. For the purposes of the following detailed description, it is to be understood that the invention may assume various alternative variations and step sequences, except where expressly specified to the contrary. Thus, before describing the present invention in detail, it is to be understood that this invention is not limited to particularly exemplified systems or embodiments that may of course, vary. The use of examples anywhere in this specification including examples of any terms discussed herein is illustrative only, and in no way limits the scope and meaning of the invention or of any exemplified term. Likewise, the invention is not limited to various embodiments given in this specification.

As used herein, the singular forms “a,” “an,” and “the” include plural reference unless the context clearly dictates otherwise. The term “and/or” means one or all of the listed elements or a combination of any two or more of the listed elements.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

When the term “about” is used in describing a value or an endpoint of a range, the disclosure should be understood to include both the specific value and endpoint referred to.

As used herein the terms “comprises”, “comprising”, “includes”, “including”, “containing”, “characterized by”, “having” or any other variation thereof, are intended to cover a non-exclusive inclusion.

The term ‘blister pack’ used herein refers to a packaging form used in pharmaceutical and confectionery packaging, comprising a cavity or pocket made from a formable film for example plastics such as PVC, polyamides, polyolefins, polyesters.

The term ‘aluminium foil’ used herein refers to aluminum metal, prepared in thin foil which could be either a hard foil or a soft foil.

The term “soft aluminium foil” or ‘soft foil’ used herein refers to soft tempered malleable aluminium foil which has better elastic property.

The term ‘hard aluminium foil’ or ‘hard foil’ used herein refers to hard tempered brittle aluminium foil which has poor elastic property but has good breaking property.

The term ‘heat seal lacquer’ used herein refers to coatings such as solvent based vinyl/acrylic resin, which are dissolved in suitable solvents like ethyl acetate, acetone, methyl ethyl ketone (MEK) etc.

The term ‘primer’ used herein refers to adhesion promoter or chemical bridges which function as a bonding layer between the substrate and the adhesive and improve the adhesion. They are used mainly on surfaces which are difficult to bond.

The term “adhesive” used herein refers to a substance used for sticking or bonding layer between the two substrates.

The term ‘polymer film’ used herein refers to plastic films which is a thin continuous polymeric material which are often used in packaging to hold items, to act as barriers, or as printable surfaces.

The object of the invention is to provide a multilayer laminated (100) aluminium lidding foil for blister pack. The object of the invention is achieved as disclosed herein below.

The multilayer laminated packaging (100) material for blister container comprises mainly of aluminium lidding foil. The multiple layers comprises a) a layer of hard or soft aluminum foil, b) a layer of adhesive, and c) a layer of polymer film.

The base pack (150) which is a thermoformed is formed in the form of a blister pack for packaging confectionery food and pharmaceutical solid dose products.

The aluminium layer (110) of the multilayered blister container (100) is the outer most layers of the blister pack. The thickness of the aluminium foil (110) is about 18 micron to 40 micron, Preferably, the thickness of the aluminium layer is about 18 micron to 25 micron. The thickness of the material is such that very little force is required to rupture the foil.

The aluminium lidding foil disclosed herein comprises a adhesive (120) for promotion of adhesion between layers. An adhesive is applied between the layers of aluminium foil (110) and the first layer of the thin polymer film (130), which ensures the bonding between aluminium foil (110) and the thin polymer film. The adhesive used herein is a solvent free adhesive. The adhesive (120) used in the present invention is selected from vinyl and/acrylic/polyurethane/polyol/epoxy.

The thin polymer film (130) has a thickness of 3 to 13 microns. Preferably, the thin polymer film has a thickness of 5 to 10 microns and most preferably the thickness of 5 to 8 microns. On application of heat, the thin polymer film seal on to the formable base film (150) of the blister pack. The thickness of the thin polymer film ensures easy rupture of the lidding foil when force is applied.

The thin polymer film (130) is made of plastic polymers such as poly vinyl chloride (PVC), polyamides, polyolefins, polyesters and laminates or multi-layered materials containing at least one of these.

The polymer layer (150) forming a base of the blister pack has a thickness of about 100 to 400 microns, more preferably a thickness of 150 to 250 microns. The second polymer layer (150) forms a blister shape so as to hold the content of the package (140), such as food or pharmaceutical products.

In a preferred embodiment, the thin polymer layer (130) and the thermoformed base layer (150) is made of same class of polymer. However, these layers may be of different class of material in some embodiments.

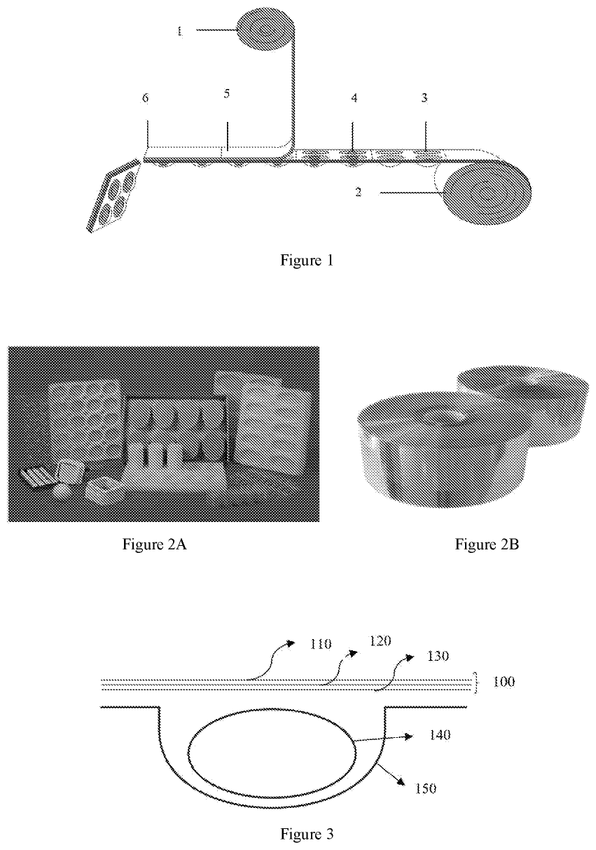

FIG. 1 depicts a scheme in an industrial process wherein a lidding material and a thermoformed base polymer layer come together to package a food or pharmaceutical product. The lidding material (1) and the thermoformed base polymer layer (2) are unwound in a packaging process, wherein a product (4) is packed in a cavity (3) of the thermoformed base polymer layer (2). A layer of lidding material (1) is heat sealed (5) and the blister package (6) is cut off evenly at the end of the process.

FIG. 2A illustrates a pictorial representation of blister packets and FIG. 2B illustrates a roll of lidding material used to seal the blister packet.

In FIG. 3, a hard or soft aluminium foil (110) is laminated on to the first side with a thin polymer film (130) of thickness 3 to 13 microns. The aluminium foil is about 18 to 40 microns in thickness. A primer coat and/or a foil wash is used on the second side of the aluminium foil. Primer coat and/or a foil wash is optionally used on the second side of the aluminium foil to make the surface printable. The laminated aluminum foil (110) polymer layer (130) is sealed to the thermoformable polymer layer (150) which forms the base of the packaging material.

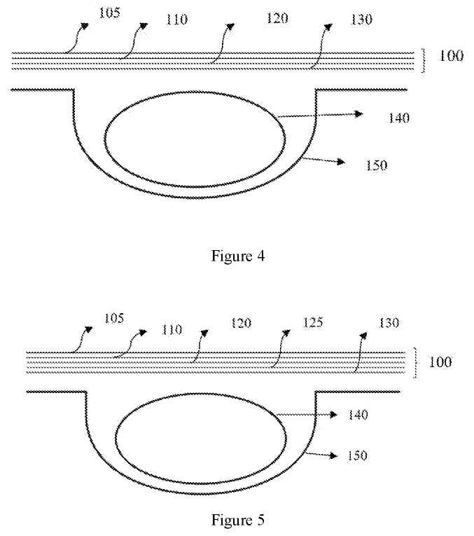

In FIG. 4, a hard or soft aluminium foil (110) is laminated on the first side with a thin polymer film (130) of thickness 3 to 13 microns. The aluminium foil is about 18 to 40 microns in thickness. A primer coat and/or a foil wash is used on the second side of the aluminium foil. Primer coat and/or a foil wash is optionally used on the first side of the aluminium foil as well. The second side of the aluminium foil may be used for printing product details using a printing ink/primer (105).

In FIG. 5, a hard or soft aluminium foil (110) is laminated on the first side with a thin polymer film (130) of thickness 3 to 13 microns. The aluminium foil (110) is about 18 to 40 microns in thickness. A primer coat and/or a foil wash is used on the second side of the aluminium foil. Primer coat and/or a foil wash is optionally used on the first side of the aluminium foil. The first (125) and the second side (105) of the aluminium foil may be used for printing product details using a printing ink/primer.

In the above embodiments, the thin polymer film (130) is thin enough to ensure that the contents of the blister pack (140) can be ejected out of it by pushing through to break the aluminum foil. Advantageously, when the second side of the aluminium foil (110) is printed as in the above embodiments, the printing ink will not leak on to the food/pharmaceutical content inside the blister pack (140), because the thin polymer film will form a barrier.

In one embodiment of the invention laminated lidding foil (100) comprises an additional layer of PET/plastic film of 10 to 25 micron above the aluminum foil (110) layer. The aluminum foil (110) in this embodiment is soft aluminum foil with a thickness of 7 to 15 micron. Such lidding foil are peel-type and can be used to seal contains mainly used as lid for butter and other products like yogurts, cheese and pickles.

In a method of packaging a blister pack using the aluminium lidding foil (110) as per the present invention, the adhesive (120) is applied between the aluminium foil layer (110) and the thin polymer layer and laminated. This laminated layer is then affixed on the blister pack by use of sufficient pressure and heat. The heat and pressure will sufficiently melt the thin polymer layer (130) of the aluminium lidding (100) on to the formable polymer film in the base (150) and thereby seal the package.

In the embodiments of the prior art wherein heat seal lacquer is used for sealing the aluminium foil (110) and the base polymer, small amount of vapor and gases of the heat seal lacquer gets locked inside the blister pack. This leakage is likely to compromise the quality of the pharma/food content (140) inside the pack. Advantageously, in the present invention, a thin polymer film (130) is laminated on to the second side of the aluminum foil which seals itself on to the base polymer (150) of the blister pack. The use of thin polymer film (130) thereby eliminates the problems of leakage of gaseous vapors of the heat seal lacquer on to the contents of the blister pack during heat sealing.

The second side of the aluminium foil is also often used to print matter in packages for food and pharmaceuticals. During filling and heat sealing, storage or due to storage condition and duration, the ink on the aluminium foil may leech to the product packed below. Since the blister pack as per the present invention has a thin polymer film offering a barrier in between the aluminium foil (110) and the formable base polymer film (150), the leeched contents are unlikely to reach the food or pharmaceutical products (140) in the cavity.

In an embodiment wherein solvent free adhesive laminated polymer film is used instead of heat seal lacquer, there is no possibility for migration of the inks, pigments and dyes into medicines and through the medicines (140) into the human body, as there is no solvent which will vaporize or form gas.

Advantageously, the thin polymer film (130) used in blister container offers better shelf life due to the barrier property. The thin polymer film (130) has a high density of 1.38 g/cm³ which provides better barrier, having lower OTR (Oxygen Transmission Rate) and WVTR (Water Vapor Transmission Rate) against present usage of heat seal lacquer.

In an embodiment the thin polymer (130) is made of special grade PVC polymer. As the thin polymer film is of 3 to 13 microns and is made of a special grade PVC, which possesses good bonding ability, the bonding between aluminium foil (110) and of the thin polymer film (130) will be much higher and provide superior sealing quality. The thin PVC film of 3 to 13 microns can be used when printed along with a wide range of anti-counterfeit special inks on the aluminium lidding foil (110). The thin PVC film (130) can also be used along with the micro size printing in order for printing the information of the medicines which also supports anti-counterfeit solutions use of anti-counterfeit special inks on the back side of the film which is not possible in present heat seal lacquer coating technology, because the heat seal lacquer coating surface cannot be as smooth as PVC film.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1.-13. (canceled)

14. A laminated lidding foil for blister container comprising;
a layer of aluminum foil,
a layer of adhesive,
a layer of polymer film,
optionally, a primer coating is applied on one or both sides of the aluminum foil,
wherein the primer coated layers provides printing surface;
wherein
the polymer film is thin and has a thickness in the range of 3 to 13 microns; and
the polymer film is melted, and heat sealed on to a polymer base of the blister container to provide easy push through.

15. The laminated lidding foil as claimed in claim 14 wherein the polymer film which is the layer is selected from poly vinyl chloride (PVC), polyamides, polyolefins, polyesters and laminates or materials containing at least one of these.

16. The laminated lidding foil as claimed in claim 14 wherein the layer which is the polymer film has a thickness of 5 to 10 microns.

17. The laminated lidding foil as claimed in claim 14, wherein the polymer film layer and the polymer base is made of same class of polymer.

18. The laminated lidding foil as claimed in claim 14, wherein the adhesive is a solvent free adhesive.

19. The laminated lidding foil as claimed in claim 14, wherein the adhesive is selected from vinyl and/acrylic/polyurethane/polyol/epoxy.

20. The laminated lidding foil as claimed in claim 14, wherein the adhesive is applied between the aluminum foil and the polymer film for lamination.

21. The laminated lidding foil as claimed in claim 14, wherein printing is done on aluminum foil and/or interior side of the aluminum foil with printing ink or anti-counterfeit security inks.

22. The laminated lidding foil as claimed in claim 14, comprising an additional layer of PET/plastic film of 10 to 25 micron above the aluminum foil layer.

23. The laminated lidding foil as claimed in claim 21, wherein the aluminum foil layer is soft aluminum foil with a thickness of 7 to 15 micron.

24. A blister package for food or pharmaceutical packaging comprising the laminated lidding foil as claimed in claim 14.

25. The laminated lidding foil as claimed in claim 14, wherein the aluminum foil has a thickness in a range of about 18 microns to 40 microns.
